(19) United States
(12) Patent Application Publication
(10) Pub. No.: US 2006/0184457 A1
(43) Pub. Date: Aug. 17, 2006

(54) Computerized conflict checking system

(75) Inventor: Sean Sanderlin, Corinth, TX (US)

Correspondence Address: JACKSON WALKER L.L.P., Suite 2100, 112 E. Pecan Street, San Antonio, TX, 78205, US

(73) Assignee: JACKSON WALKER, LLP

(21) Appl. No.: 11/346,933

(22) Filed: Feb. 3, 2006

Related U.S. Application Data
(62) Division of application No. 09/922,210, filed on Aug. 3, 2001.

(51) Int. Cl. G06Q 99/00; H04L 9/00; H04K 1/00

(52) U.S. Cl. 705/80; 705/1

(57) ABSTRACT

The present invention is herein described as a computerized method for checking and clearing relationship problems in an organization including a plurality of members and a conflicts administrator. The present invention receives and stores data denoting existing client information within a central database. Upon potential client information being inputted, the system automatically compares such information with the stored existing client information to determine is any matches are present. Additionally, the present invention receives and transmits potential client information for display upon each of a plurality of terminals such that each member of the organization may review potential client information and communicate any potential conflicts of interest. The individual requesting a conflict check or new client file is provided with an electronic record illustrating the results of the comparison performed by the system as well as feedback from each member of the organization.

This application is a divisional application of and claims priority from U.S. application Ser. No. 09/922,210 filed Aug. 3, 2001 and incorporates by reference the '210 application as if it were fully printed herein.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### FIELD OF THE INVENTION

The present invention relates to methods of computerized organizational administration and, more particularly, to a method of operating a computer system to check and clear relationship problems in an organization having a plurality of members.

### BACKGROUND OF THE INVENTION

Organizations having a large number of members that deal with parties outside of the organization can encounter serious difficulties in coordination of the individual efforts. For example, professional service firms such as law firms must avoid conflicts of interest. A law firm normally cannot properly represent a first party against a second party if the second party is already a client of the firm. A law firm normally cannot represent one party in negotiations with another party if the other party is a client of the firm, unless both parties waive the potential conflict. Numerous other situations can also give rise to conflicts which can result in the organization being unable to represent a potential client.

Some law firms seek to avoid conflicts by circulating hard copy memoranda of potential new matters to all of their attorneys, so that each attorney can review all incoming clients and/or matters and voice any objections. However, if the attorney capable of spotting the potential conflict is absent when the memorandum is circulated, the conflict may go unnoticed.

Many law firms utilize computerized systems for the initial stages of a conflict checking process. Such systems typically store identifications of clients of the firm, their affiliates, owners and other parties related to the firm, and also store corresponding information for adversaries and other parties involved in matters handled by the firm. Information about a prospective new client and/or adversary is entered and compared with information already stored in the system. A report listing the potential conflicts is furnished to an individual or committee and that person makes a professional determination as to whether or not a true conflict exists. For example, if the computerized comparison of data shows that the corporate name of a potential defendant in a suit to be initiated on behalf of a prospective client is the same as the corporate name of an existing client, the attorney reviewing the situation may find that, in fact, the two corporations are different and unrelated and that there is no conflict.

In other matters, the attorney reviewing the conflict may be able to obtain a waiver of the conflict from the existing client and from the potential new client. The attorney reviewing the conflicts may consult with other attorneys in the firm, including the attorney responsible for conducting business with the existing client involved in the potential conflict. After the potential conflict is resolved, the attorney responsible for accepting or opening the new matter, and the firm's file department are advised, and they can then proceed to open the new matter as a case being handled by the firm.

Effective conflict screening with such a system is inherently slow and cumbersome. In a large firm with many attorneys opening new matters, many potential conflicts will be identified each day. For each potential conflict, clerical personnel must consult the appropriate records and file and circulate information concerning the potential conflict to the appropriate attorneys. The clerical personnel normally circulate sign off sheets to various attorneys to secure approval for accepting or opening the new matter. Hours or days can elapse between the initial inquiry with regard to a possible new matter and receipt of clearance to open the matter and commence work. If one or more of the attorneys or clerks involved in the process is absent or otherwise occupied, the clearing process will come to a halt. The attorney who initiated the potential new matter normally has no way to determine where his or her matter is in the system, and has no convenient way to expedite clearance if the matter is especially urgent. This leads to considerable loss of time as the initiating attorney attempts to find the point in the process where his or her matter is being delayed, as by telephoning all of the people potentially involved in the conflict clearing process.

All of these problems become even more serious as the size of the firm, and the complexity of its business increase. These problems are further magnified in firms having multiple offices.

U.S. Pat. No. 5,774,866, the '866 patent, describes a computerized system used to determine if a conflict of interest exists. The '866 patent describes a system that compares data concerning potential relationships of a party to the organization with stored data representing existing relationships and identifies potential problem situations where the client in a potential matter is the same as the client in an existing matter. For at least some of these matches, the '866 patent uses stored data defining associations between existing parties and persons within the organization to select one or more persons within the organization associated with the existing party, and sends a signal denoting the potential problem to one or more of the persons. The potential problem signal is selectively routed to only those persons concerned. The system allows concerned persons to signal the system that the problem does not exist, or that the problem has been resolved.

Although an improvement upon prior systems, the invention described in the '866 patent is capable only of determining potential conflicts of interest for parties having information stored upon the system. Often, an attorney will not input potential client information into the system until there is a reasonable chance that his or her representation will be retained or an initial office conference has been scheduled. It is also possible that an attorney may neglect to enter such information into the system given the hectic nature of operating a law practice. The '866 patent is only capable of comparing client information that is stored upon the system.

To illustrate, lets assume that attorney A names Jane Doe as a potential client and John Doe as potentially adverse and inputs same into the system. Lets further assume that attorney B has expended considerable time and effort courting business from John Doe, but has not yet entered such information into the system. The invention described in the '866 patent provides conflict information “only to those persons concerned”, as defined by the information that has been entered into the system. Thus, in this example, the invention describes by the '866 patent would not inform attorney B of the proposed adverse relationship with John Doe because attorney B would not be considered a “concerned person”. To ensure that all potential conflicts are addressed, each individual attorney must be given the opportunity to review and respond to each potential client inquiry.

### SUMMARY OF THE INVENTION

Accordingly, the present invention provides a computerized conflict checking system capable of providing potential client information to each member of an organization such that each member may efficiently communicate any known conflicts of interests to the requesting party. The present invention receives and stores data denoting existing client information within a central database. Upon potential client information being inputted, the system automatically compares such information with the stored existing client information to determine is any matches are present.

In addition to the above electronic comparison, potential client information is transmitted for display upon each of a plurality of terminals such that each member of the organization may review the potential client information displayed upon the terminals and communicate any potential conflict of interest. Thus, the individual requesting a conflict check or new client file is provided with an electronic record illustrating the results of the comparison performed by the system as well as feedback from each member of the organization, if any.

### BRIEF DESCRIPTION OF THE DRAWINGS

FIG. 1 is an illustration of one embodiment of the computer system of the present invention.

FIG. 2 is a flowchart illustrating the two tiered process used in one embodiment of the present invention.

FIGS. 3-5 illustrate overview form display screens used in one embodiment of the present invention.

FIGS. 6-8 illustrate client form display screens used in one embodiment of the present invention.

FIGS. 9-10 illustrate matter form display screens used in one embodiment of the present invention.

FIG. 11 illustrates a conflict notification display screen used in one embodiment of the present invention.

FIG. 12 illustrates a potential client inquiry display screen used in one embodiment of the present invention and having an unchecked conflict box.

FIG. 13 illustrates a potential client inquiry display screen used in one embodiment of the present invention and having a checked conflict box.

FIG. 14 illustrates a comment display screen used in one embodiment of the present invention.

FIG. 15 illustrates a status page display screen used in one embodiment of the present invention.

### DETAILED DESCRIPTION OF THE INVENTION

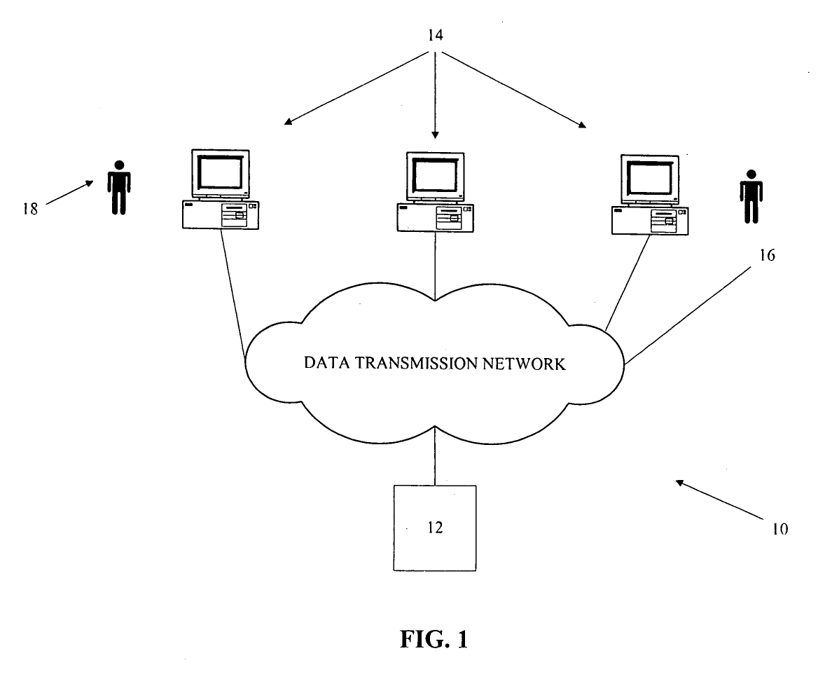

The present invention is herein described as a computerized method for checking and clearing relationship problems in an organization having a plurality of members (18) and as a computer readable medium comprising a plurality of instructions for checking and clearing relationship problems in an organization which, when read by a computer, causes the computer to perform a series of steps. Referring to FIG. 1, the present invention makes use of a computer system (10) having a central database (12) connected to a plurality of computer terminals (14) through a data transmission network (16).

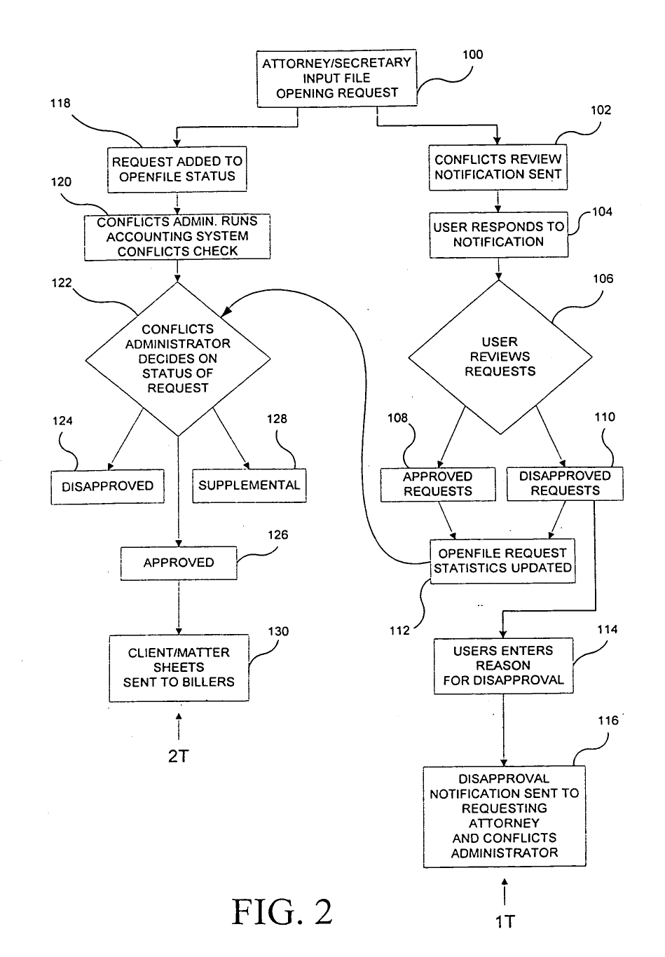

Referring to FIG. 2, the computer system (10) of the present invention uses a two tiered process to perform conflict checks and open new client files. The first process tier (IT) of the present invention is designed to receive potential client data, transmit this data to each member (18) of the organization and provide each member with an opportunity to review and/or respond, if necessary. The second process tier (2T) of the present invention is designed to receive potential client data, compare the data to pre-existing client data held upon the database (12) and report any matches. The present invention is capable of operating the first and second process tiers (1T and 2T, respectively) simultaneously in order to provide conflict information in a short period of time.

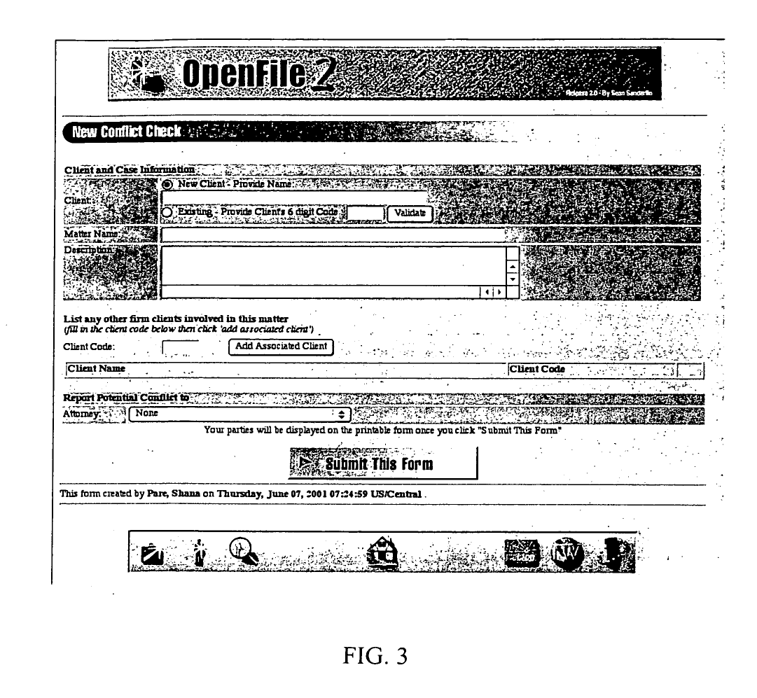

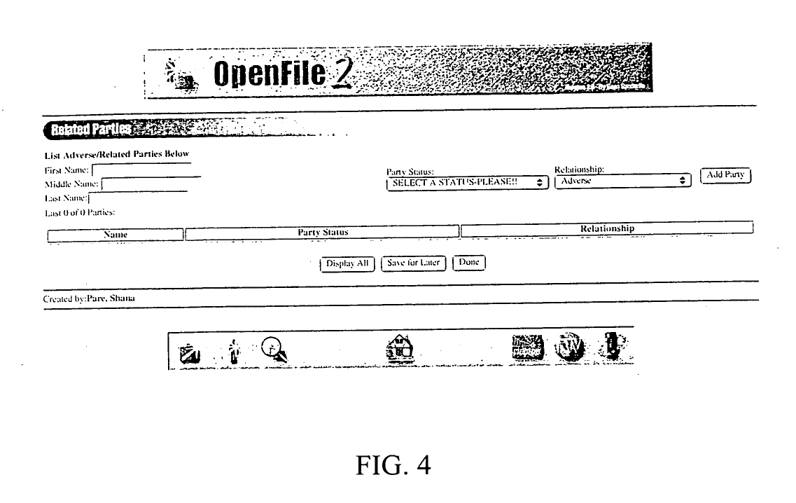

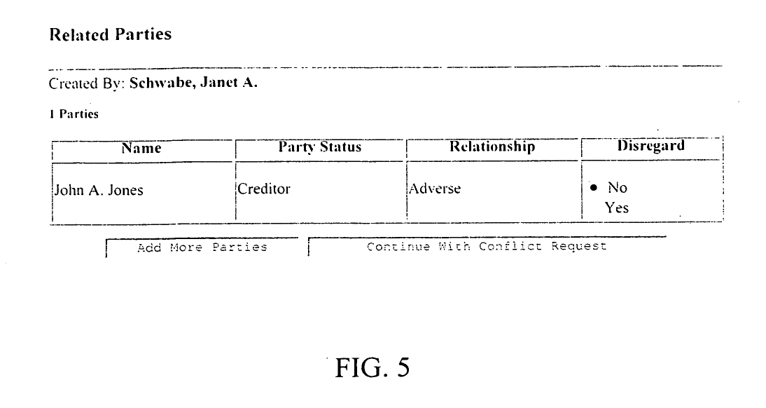

The first process tier (1T) of the present invention is designed to facilitate member (18) responses to each potential client inquiry (22) and provide the requesting party with valuable conflict information. Accordingly, the present invention requires a mechanism for the entry of input data. Referring to Block 100 of FIG. 2, the present invention provides each member (18) of the organization with a graphic user interface for use in entering information. In one embodiment of the present invention, three electronic forms are provided for data entry into the system. The first of these forms is referred to as the overview form and is illustrated in FIGS. 3-5. Using the overview form, members of the organization may enter information such as client name/code, matter name, description of the type of work anticipated, existing clients known to be involved in the matter, the name of the requesting attorney, and related parties, if any

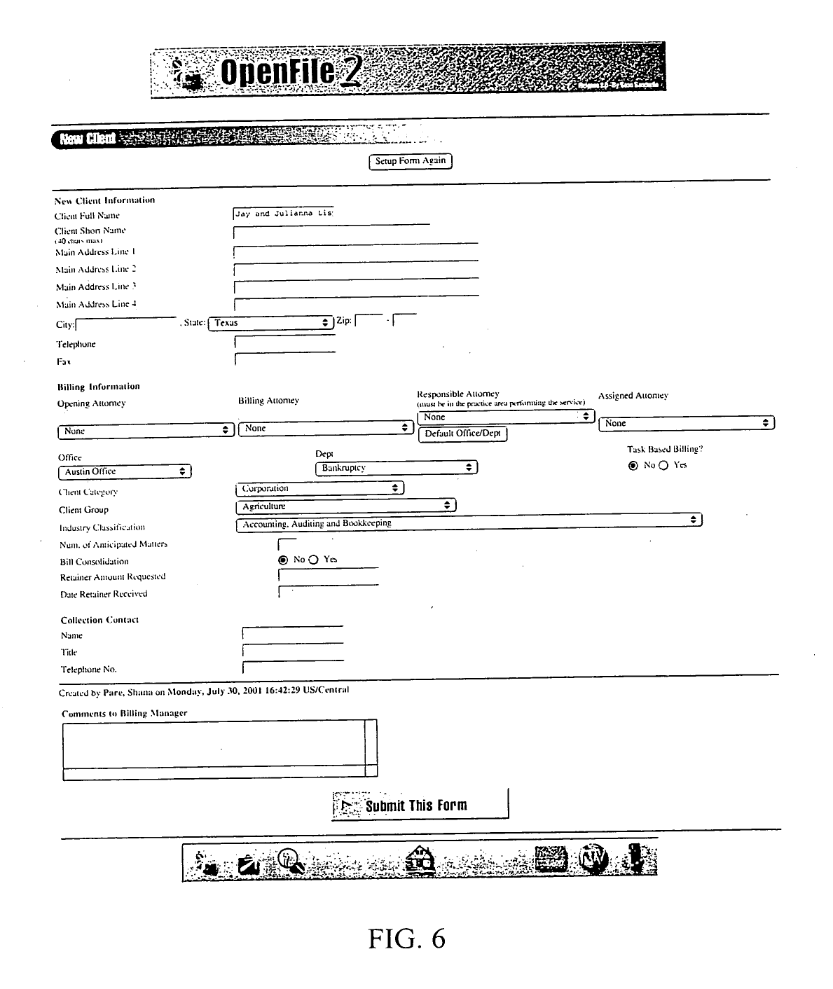

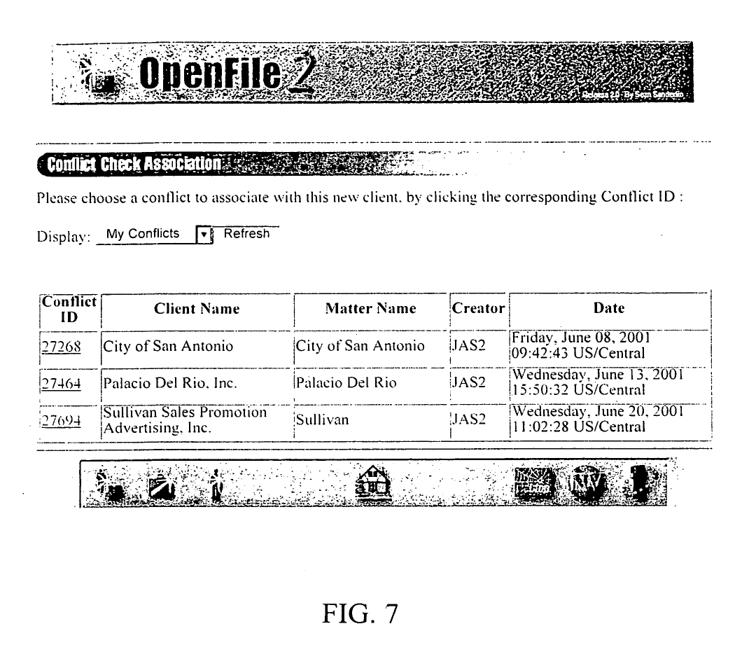

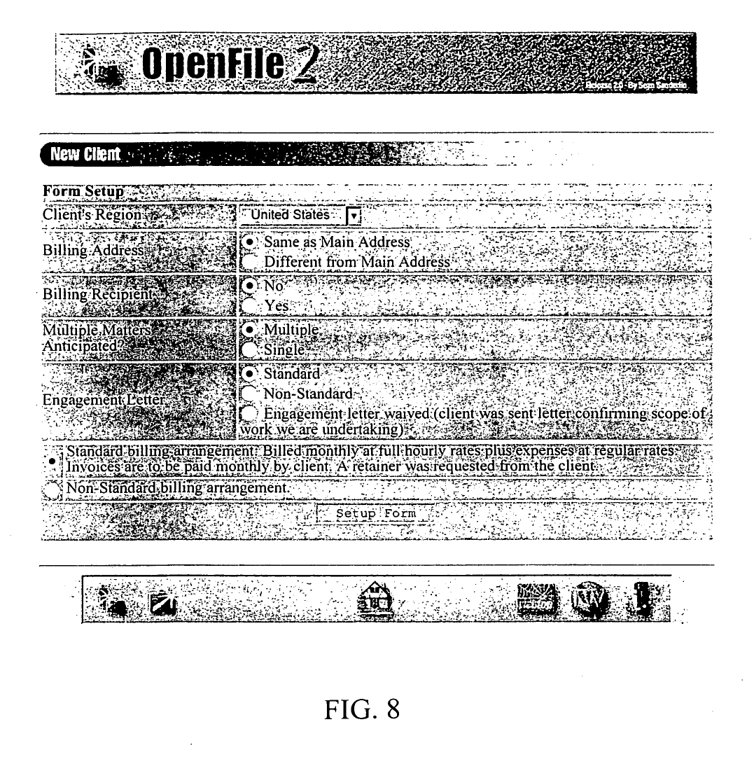

Only the overview form must be completed for the system to initiate a conflicts check. However, additional data must be entered in order to open a new client file. In one embodiment, the present invention provides a second opening request form to facilitate the creation of a new client file. This form is referred to as the client form and is illustrated in FIGS. 6-8. Using the client form, members of the organization enter data such as:
client name,
address,
phone/fax number,
opening/billing/responsible/assigned attorneys,
default billing office,
default billing department,
client category,
group,
industry classification,
retainer information,
billing address,
billing recipient,
collection contact,
engagement letter information, and
billing rates/expenses/billing/payment cycle.

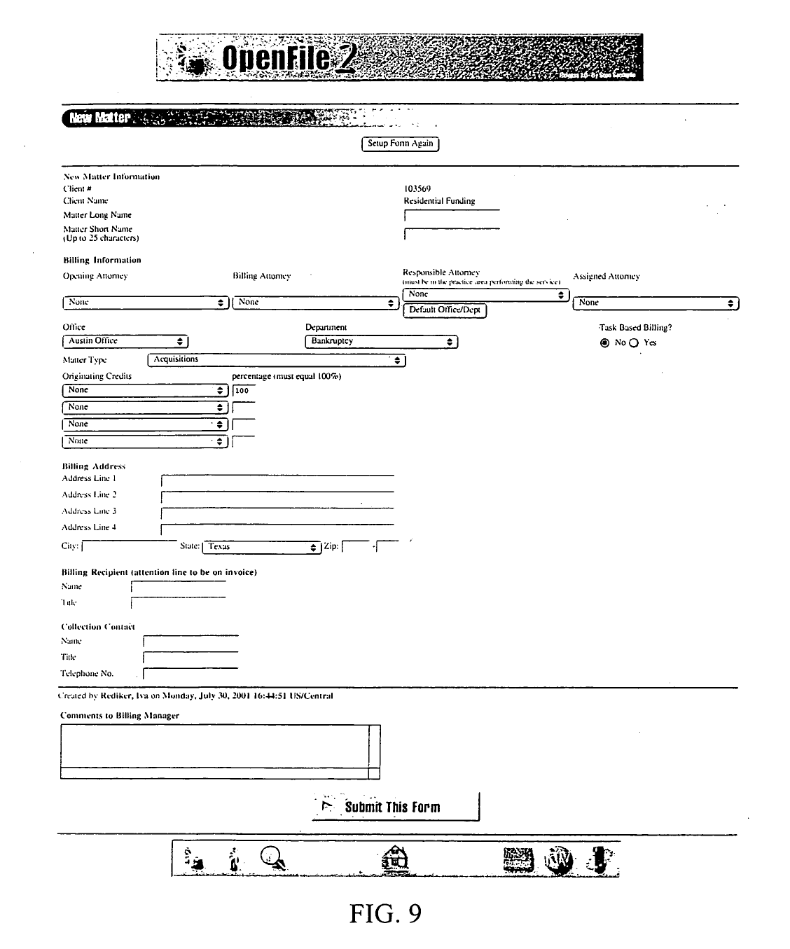

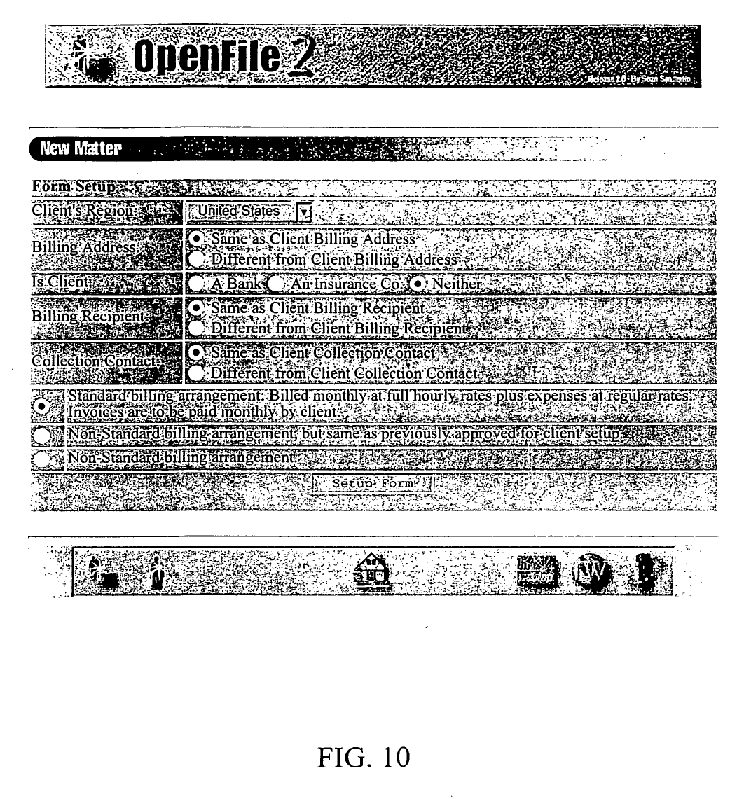

To open a new matter for a new or existing client, the member is required to enter additional data into the system. In one embodiment, the present invention provides a third electronic file opening request form to facilitate the creation of a new matter. This form is referred to as the matter form and is illustrated in FIGS. 9-10. Using the matter form, members of the organization enter data such as:
client name,
matter name (long and short),
phone/fax,
opening/billing/responsible/assigned attorneys,
default billing office,
default billing department,
matter type,
originating credits,
billing address (if different from client),
billing recipient (if different from client),
collection contact (if different from client),
billing rates/expenses/billing/payment cycle (if different from client), and
additional info related to specific client types.

Once potential client information has been entered into the system (10), it is transmitted to the database (12) for storage and assigned a unique identification number so that each request may be tracked through the system. Referring to Block 102 of FIG. 2, data entered via the overview form is automatically copied and transmitted through the data transmission network (16) to be displayed upon each terminal (14).

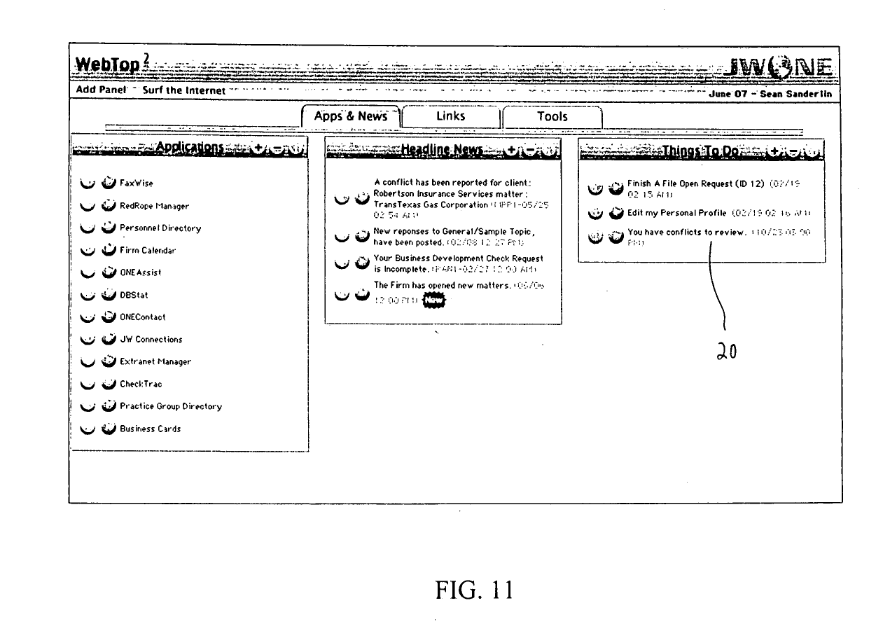

Referring to FIG. 11 and Block 104 of FIG. 2, the present invention provides a unique graphic user interface to inform each member of the organization that fresh potential client information has been posted. In one embodiment, a hyperlink entitled “You have conflicts to review” (20) is displayed upon each member's terminal (14). In one embodiment, the member is provided access to a hyperlink through an Intranet homepage or similar interface. To access the conflict review notification, the member need only click his or her mouse upon the hyperlink or other electronic notification.

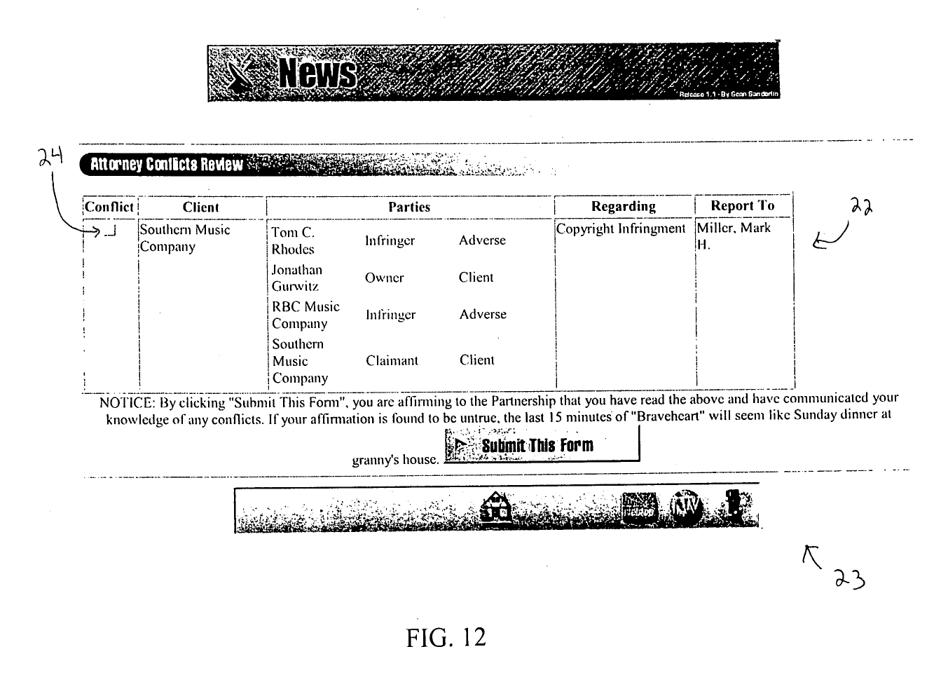

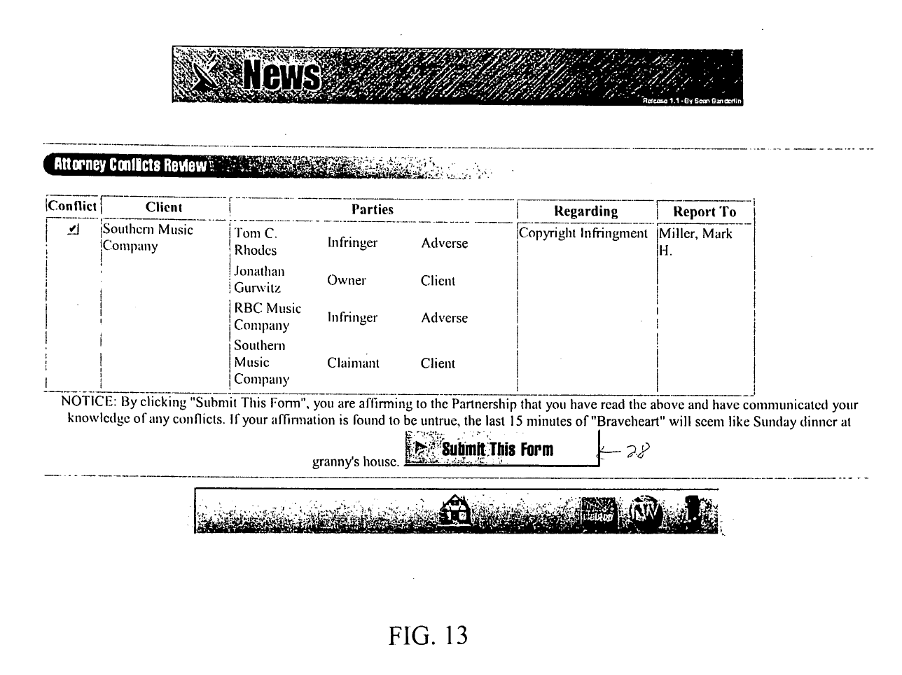

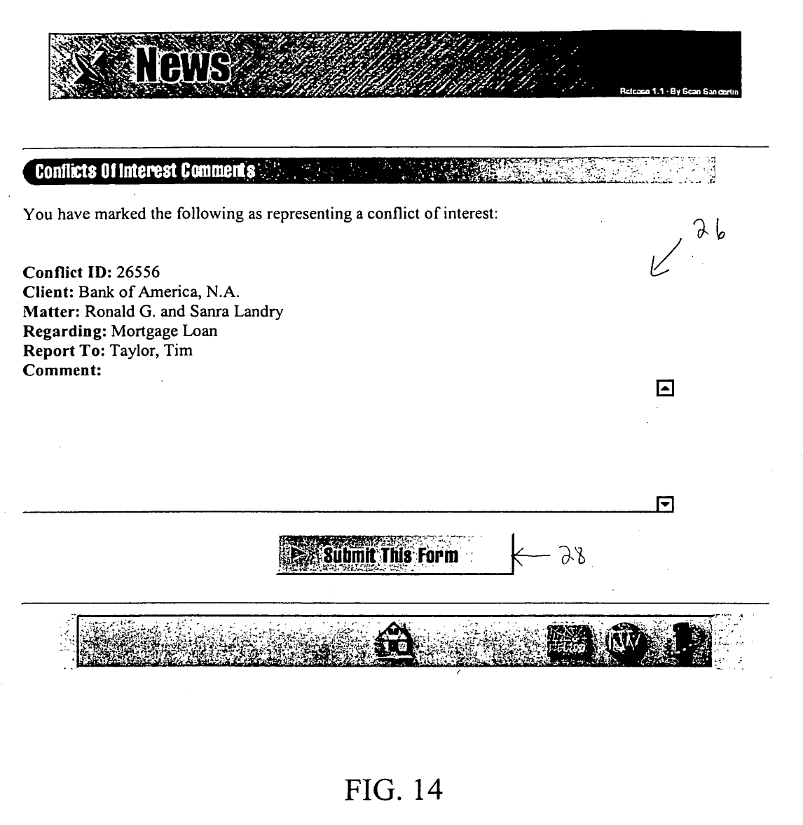

Referring to FIG. 12 and Block 106 of FIG. 2, upon accessing the conflict notification, the member (18) is automatically provided access to the potential client inquiry (22). Specifically, upon clicking upon the notification, (20) information entered via the overview form by the requesting party is immediately displayed upon the member's terminal (14) display screen. In one embodiment of the present invention, a conflict box (24) is provided adjacent to each potential conflict inquiry (22). If a member (18) of the organization has relevant information regarding a potential client or any associated parties, he or she need only click the mouse button upon the conflict box (24), as illustrated in FIG. 13. Upon clicking upon a conflict box (24), a comment screen (26) having form fields for data entry is presented. Referring to FIG. 14 and Block 114 of FIG. 2, the comment screen allows the member (18) to input conflict information into the system (10).

The present invention allows members of the organization to click multiple conflict boxes (24) and provide relevant information for as many potential client inquiries (22) as are necessary. In one embodiment, the member (18) is returned to the conflict review screen (23) once he or she has entered information upon the comment screen (26). At this point the member (18) may complete his or her review of potential client inquiries (22) by clicking upon a complete form button (28). In one embodiment, the present invention provides a “Submit This Form” button (28) to allow each member to complete his or her review of the potential client inquiries (22). The conflict review screen of the present invention may also contain a certification notice adjacent to the complete form button (28). In one embodiment, the certification notice informs each member of the organization that the act of clicking the complete form button constitutes an affirmation to the organization that the member has reviewed all potential conflict inquiries on the conflict review screen (23) and that the member has communicated any potential conflicts to the organization.

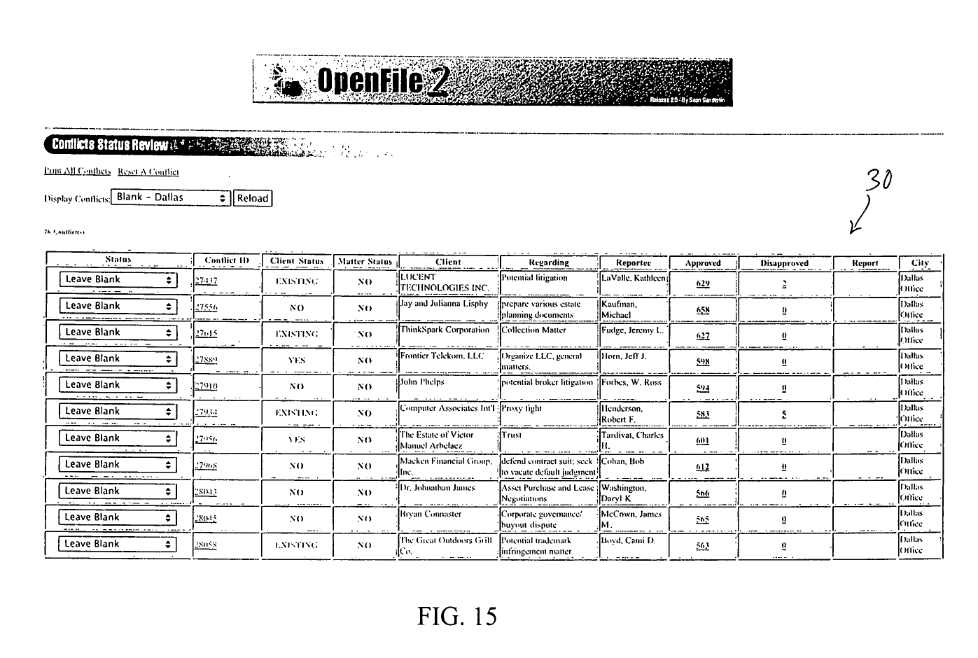

Referring to FIG. 15 and Blocks 108 and 110 of FIG. 2, once the member (18) has completed his or her review by clicking upon a complete form button (28), the present invention automatically identifies potential conflict inquiries (22) having a conflict box (24) checked as “disapproved” and those not having a conflict box checked as “approved”. Referring to Block 122 of FIG. 2, this information is noted in a database record and is used to update the open file status page (30) with updated information. Referring to Block 122 of FIG. 2, the status page is then reviewed by the conflicts administrator as described in greater detail below.

Referring to Blocks 116 and 122 of FIG. 2, a notification of each disapproved potential client inquiry is transmitted to both the conflicts administrator and to the member (18) requesting the conflict check or new client file. In one embodiment, this notification is represented as a hyperlink upon an Intranet homepage and includes the client/matter name, the requesting attorney's name, and the comments of the responding organization member. This information may then be reviewed by the party requesting the potential client inquiry or the conflicts administrator as described below.

As discussed in detail above, the first process tier (IT) of the present invention is designed to provide feedback from each member (18) of the organization in a short period of time. Alternatively, the second process tier (2T) of the present invention is designed to receive potential client data, compare the data to pre-existing client data held by the database (12) and report any matches. Referring to Blocks 100 and 118 of FIG. 2, potential client inquiries (22) are entered into the system and transmitted to the database (12) for storage. Upon receipt by the database (12), an inquiry is immediately assigned a “blank” status to signal the conflicts administrator that a new inquiry has been entered. In one embodiment, the conflicts administrator accesses inquiry information through a status page (30) accessible by the conflicts administrator through an Intranet homepage. As the conflicts administrator receives additional information, the status of the inquiry is updated accordingly, as illustrated in FIG. 2.

Referring to Block 120 of FIG. 2, upon receiving new potential client data, the present invention automatically compares the data to all pre-existing client records held upon the database (12). Potential client data is deemed to match pre-existing client data when data designating a potential party and data designating an existing party correspond with one another to at least a pre-selected degree of similarity. In one embodiment, accounting records detailing every aspect of the organization's representation of existing clients are used for comparison to potential client data.

The two process tiers (1T and 2T, respectively) of the present invention work together to provide the requesting party with a computerized comparison of existing records as well as feedback from other organization members (18). Each response provided by organizational members (18) is transmitted not only to the requesting party but also to the conflicts administrator. The results of the electronic comparison and feedback from organization members is compiled and reviewed by the conflicts administrator. The administrator may then make a decision as to whether a conflict of interest exists and/or if a new client file may be opened.

Referring to Blocks 122, 124, 126 and 128 of FIG. 2, in one embodiment, the conflicts administrator may disapprove the request, mark the inquiry as supplemental, or approve the inquiry. If the request is disapproved, the computer system of the present invention removes the inquiry from the pending request screen (not shown) of the status page (30) and archives the inquiry. If the inquiry is marked as supplemental, it is deemed to be contingent upon a previous inquiry and removed from the pending request screen of the status page and archived. In this instance, the supplemental inquiry is automatically reviewed when a decision is made as to the previous inquiry upon which the supplemental inquiry is based.

Referring to Blocks 130 and 132 of FIG. 2, if the request is marked as approved, the computer system of the present invention transmits client and matter information forms to the billing managers. The billing managers then input the information into the system (10) such that the system may create a new client matter number. Once this is completed, an electronic notification containing client/matter forms and the new client matter number is transmitted to the requesting party.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

What is claimed:

1. A conflict resolution method comprising the steps of:
receiving a plurality of potential client inquiries from members of an organization, said inquiries comprising party information and relationship information;
displaying all of said potential client inquires to each member of said organization via a graphic user interface, said graphic user interface further displaying a conflict box adjacent to each of said plurality of potential conflict inquiries;
displaying a potential client inquiry comment screen upon said member checking at least one of said conflict boxes;
receiving inquiry response information relating to said potential client inquiry adjacent to the conflict box checked by said user;
transmitting said inquiry response information to a requesting attorney associated with said potential client inquiry; and
requiring each member of the organization to indicate that they have reviewed and commented on all potential client inquiries.

2. The method of claim 1, wherein said graphic user interface further comprises a completion button.

3. The method of claim 2, wherein said graphic user interface further comprises a certification notice adjacent to said completion button.

4. The method of claim 3, wherein said certification notice informs each member that the act of clicking said completion button constitutes an affirmation to the organization that the member has reviewed all potential conflict inquiries and communicated any potential conflicts to the organization.
